(19) United States
(12) Patent Application Publication
(10) Pub. No.: US 2026/0246140 A1
(43) Pub. Date: Aug. 20, 2026

(54) ANTENNA DEVICE INCLUDING COVERING LAYER

(71) Applicant: MEDIATEK INC., Hsinchu City (TW)

(72) Inventor: Nai-Chen Liu, Hsinchu City (TW)

(73) Assignee: MEDIATEK INC., Hsinchu City (TW)

(21) Appl. No.: 19/263,524

(22) Filed: Jul. 9, 2025

Related U.S. Application Data
(60) Provisional application No. 63/759,218, filed on Feb. 16, 2025.

(51) Int. Cl. H01Q 1/42

(52) U.S. Cl. CPC H01Q 1/42

(57) ABSTRACT

An antenna device includes an antenna radiator and a covering layer. The antenna radiator is used to transmit a wireless signal. The covering layer is formed above the antenna radiator. The wireless signal is transmitted through at least the covering layer. The antenna radiator and the covering layer are separated by a predetermined distance, and the predetermined distance is less than 1/10 of a wavelength of the wireless signal. The covering layer can have a hole, and a portion of an orthogonal projection of an edge of the antenna radiator can pass through the hole in a top view.

### CROSS REFERENCE TO RELATED APPLICATIONS

This application claims the benefit of U.S. Provisional Application No. 63/759,218, filed on Feb. 16, 2025. The content of the application is incorporated herein by reference.

### BACKGROUND

With the continuous advancement of communication technology, antenna-related applications have become increasingly prevalent across various electronic devices. Taking portable devices as examples, such as mobile phones and smartphones, antennas must be embedded within the device body to maintain functionality while preserving design requirements.

In such applications, multiple critical factors must be simultaneously considered and optimized. Accuracy, compactness, reliability, manufacturing difficulty, and wireless transmission and reception performance all constitute essential considerations that directly impact device functionality and user experience. These requirements often present conflicting constraints that create complex engineering challenges requiring sophisticated design approaches.

Despite ongoing research efforts in the technical field, current solutions continue to present limitations and trade-offs that prevent optimal satisfaction of all these critical requirements simultaneously. The field remains in need of improved approaches that can better address these multifaceted technical challenges.

### SUMMARY

An embodiment provides an antenna device. The antenna device includes an antenna radiator and a covering layer. The antenna radiator is used to transmit a wireless signal. The covering layer is formed above the antenna radiator. The wireless signal is transmitted through at least the covering layer. The antenna radiator and the covering layer are separated by a predetermined distance, and the predetermined distance is less than 1/10 of a wavelength of the wireless signal. the covering layer has a hole, and a portion of an orthogonal projection of an edge of the antenna radiator passes through the hole in a top view.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a portion of an antenna device in a side cross-sectional view according to an embodiment.

FIG. 2 shows a portion of the antenna device in a top view.

FIG. 3 shows a portion of an antenna device in a side cross-sectional view according to another embodiment.

FIG. 4 shows a portion of an antenna device in a side cross-sectional view according to another embodiment.

FIG. 5 shows a portion of an antenna device in a side cross-sectional view according to another embodiment.

FIG. 6 shows a plurality of three-layer stacked structures according to embodiments.

FIG. 7 shows an antenna device according to an embodiment.

FIG. 8 to FIG. 10 show the covering layers in FIG. 7 in a top view.

FIG. 11 shows a plurality of hole shapes applicable to at least one covering layer in top view.

### DETAILED DESCRIPTION

In this document, when referring to the shape of a hole formed in a layer, it refers to the shape of the cross-sectional area of the hole in a top view. In this document, when referring to the shape of an antenna radiator, it refers to the shape of the antenna radiator in a top view. In this document, when referring to the size of a hole, it refers to the size of the cross-sectional area of the hole in a top view. In this document, when referring to an edge of an antenna radiator passing through a hole, it means that at least a portion of an orthogonal projection of the edge of the antenna radiator passes through the hole in a top view. In this document, when referring to two holes that at least partially overlap, it means that projections of the holes at least partially overlap in a top view.

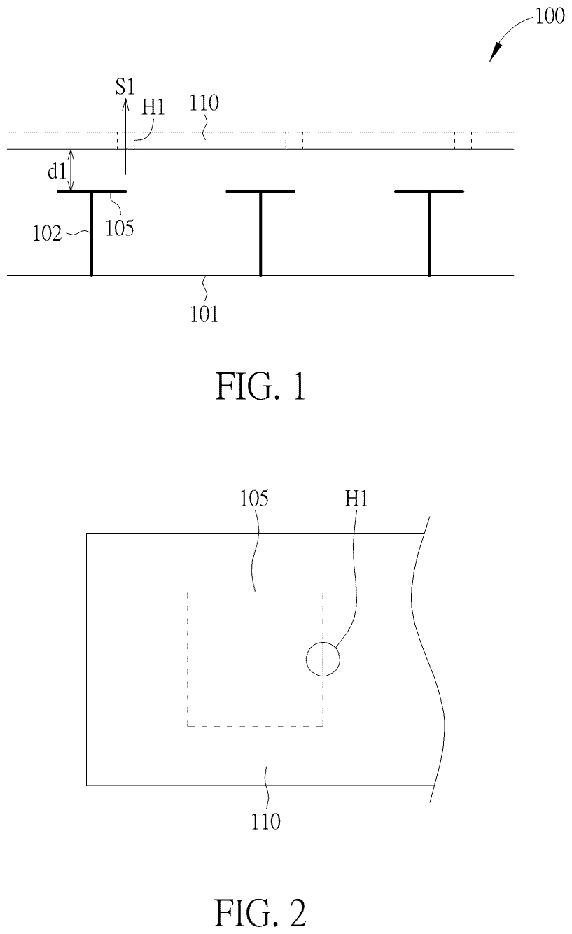

FIG. 1 shows a portion of an antenna device 100 in a side cross-sectional view according to an embodiment. The antenna device 100 can include an antenna radiator 105 and a covering layer 110. The antenna radiator 105 can be used to transmit a wireless signal S1. The covering layer 110 can be formed above the antenna radiator 105. The antenna radiator 105 can be positioned on a plane 101 and supported by a fixing element 102.

With respect to the fixing element 102, in addition to providing mechanical support for the antenna radiator 105, in alternative embodiments, the fixing element 102 can further function as a feed structure for transmitting wireless signal S1 to the antenna radiator 105 or for receiving wireless signal S1 therefrom. For example, the fixing element 102 can include a coaxial feed, a probe feed, a microstrip transmission line or other suitable hardware structures. The fixing element 102 can maintain stable positioning of the antenna radiator 105 relative to the plane 101 while concurrently establishing the requisite electrical connection.

The wireless signal S1 can be transmitted through at least the covering layer 110. The antenna radiator 105 and the covering layer 110 can be separated by a predetermined distance d1. The predetermined distance d1 can be less than 1/10 of a wavelength (denoted as λ) of the wireless signal S1, which can be expressed as d1<0.1λ. The covering layer 110 can have a hole H1.

FIG. 2 shows a portion of the antenna device 100 in a top view. In the example of FIG. 2, the shape of the antenna radiator 105 is rectangular, and the shape of the hole H1 is circular, but embodiments are not limited thereto. As shown in FIG. 2, a portion of an edge of the antenna radiator 105 can pass through the hole H1 in a top view. That is to say, the hole H1 can be formed near an edge of the antenna radiator 105 in a top view.

FIG. 3 shows a portion of an antenna device 300 in a side cross-sectional view according to another embodiment. Similar to the antenna device 100, the antenna device 300 has an antenna radiator 105, and a covering layer 110 formed above the antenna radiator 105. However, the antenna device 300 further includes a covering layer 120 formed adjacent to the covering layer 110. The wireless signal S1 can be transmitted through the covering layer 110 and the covering layer 120.

In FIG. 3, the covering layer 120 can be formed above the covering layer 110, and the covering layer 110 can be formed between the antenna radiator 105 and the covering layer 120. However, this is an example, and embodiments are not limited thereto.

In another embodiment, the covering layer 120 can be formed below the covering layer 110, which means that the covering layer 120 can be formed between the antenna radiator 105 and the covering layer 110. According to embodiments, the covering layer 120 can be formed below the covering layer 110, and the covering layer 120 can be without a hole, or can have a hole.

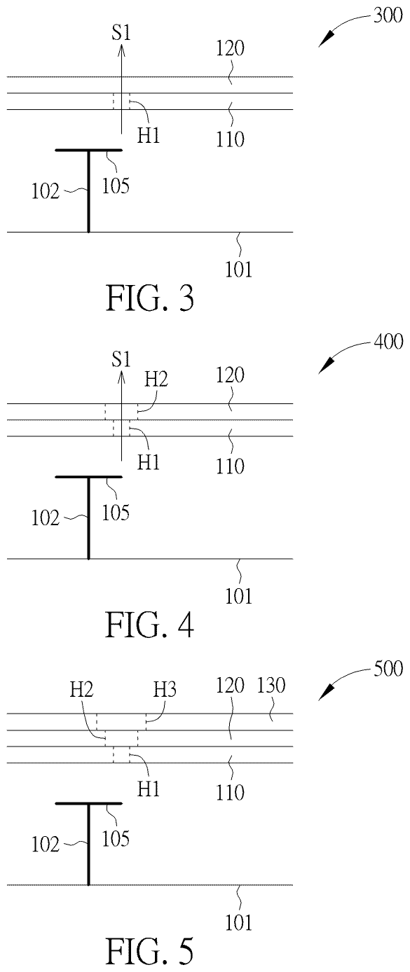

In FIG. 3, the covering layer 120 can be without a hole. However, embodiments are not limited thereto. FIG. 4 shows a portion of an antenna device 400 in a side cross-sectional view according to another embodiment. Similar to the antenna device 300, the antenna device 400 can include the covering layer 110 and the covering layer 120 to form a two-layer stacked structure. In the antenna device 400, the covering layer 120 can have a hole H2.

The projections of the hole H1 and the second hole H2 can at least partially overlap. That is to say, the hole H2 can also be formed near an edge of the antenna radiator 105 in a top view.

In FIG. 4, the hole H2 can be larger than the hole H1, but this can be merely an example. In a top view, the size of the hole H1 and the size of the hole H2 can be the same or different. The size of H1 can be larger than or smaller than the size of H2. The size relationship can be expressed as the hole H1 being equal to the hole H2 (H1=H2), the hole H1 being larger than the hole H2 (H1>H2), or the hole H1 being smaller than the hole H2 (H1<H2), all of which can be allowable structures in embodiments.

According to embodiments, by using various sizes of the lower hole (closer to the antenna radiator 105) and the upper hole (farther from the antenna radiator 105), the wireless signals transmitted by the antenna radiator 105 can be focused or dispersed.

The principle is mainly based on locally changing the effective dielectric constant of the region for wireless signals by adjusting the size of holes in the stacked covering layers. Larger holes can reduce the effective dielectric constant of the covering layer (closer to the dielectric constant of air), while smaller holes can make the effective dielectric constant relatively higher (closer to the dielectric constant of the covering layer material itself). The deliberately formed gradient of effective dielectric constant in space can control the propagation path of wireless signals because of the refraction effects.

If a hole is not filled with a predetermined material, the medium within the hole can be considered as air. One or both of the hole H1 and the hole H2 can be filled with a predetermined material to adjust the effective dielectric constant of at least one of the covering layer 110 and the covering layer 120. Therefore, according to embodiments, the hole H1 and the hole H2 can contain air. Alternatively, the hole H1 can contain air, and the hole H2 can be filled with material. Alternatively, the hole H1 can be filled with material, and the hole H2 can contain air. Alternatively, the hole H1 can be filled with a first material, and the hole H2 can be filled with a second material. All of the above fall within the scope of embodiments. The first material filled in the hole H1 and the second material filled in the hole H2 can be the same or different.

According to embodiments, the hole H1 and the hole H2 can have the same shape in a top view. For example, if the hole H1 is circular, then the hole H2 can be circular. However, the shape of the holes is not limited thereto. Related descriptions and examples will be provided hereinafter.

FIG. 5 shows a portion of an antenna device 500 in a side cross-sectional view according to another embodiment. Similar to FIG. 4, the antenna device 500 can have the covering layer 110 and the covering layer 120 formed above the antenna radiator 105. However, the antenna device 500 can further include a covering layer 130 formed adjacent to one of the covering layer 110 and the covering layer 120. The covering layer 110, the covering layer 120, and the covering layer 130 can form a three-layer stacked structure.

In FIG. 5, the covering layer 130 can be formed adjacent to the covering layer 120, and the covering layer 120 can be formed between the covering layer 110 and the covering layer 130.

However, FIG. 5 is an example. In another embodiment, the covering layer 130 can be formed between the covering layer 110 and the covering layer 120.

In another embodiment, the covering layer 110 can be formed between the covering layer 130 and the covering layer 120.

In other words, from top to bottom, the stacking order of the covering layer 110, the covering layer 120, and the covering layer 130 can be any possible arrangement. As long as these three layers (i.e., the covering layer 110, the covering layer 120, the covering layer 130) form a three-layer stacked structure above the antenna radiator 105, such arrangements all fall within the scope of embodiments.

In the three-layer stacked structure formed by the covering layer 110, the covering layer 120, and the covering layer 130, a topmost layer (the covering layer farthest from the antenna radiator 105) can have a first effective dielectric constant, a middle layer can have a second effective dielectric constant, and a bottom layer (the covering layer closest to the antenna radiator 105) can have a third effective dielectric constant. The second effective dielectric constant can be between the first effective dielectric constant and the third effective dielectric constant.

According to embodiments, the covering layer 120 can have a hole, or can be without a hole. According to embodiments, the covering layer 130 can have a hole, or can be without a hole.

In the example of FIG. 5, from bottom to top, the sequence is the covering layer 110, the covering layer 120, and the covering layer 130, and the covering layer 110, the covering layer 120, and the covering layer 130 all have holes. The covering layer 110 has a hole H1. The covering layer 120 has a hole H2. The covering layer 130 has a hole H3. Projections of the holes H1, H2, and H3 can at least partially overlap.

The sizes of any two of the holes H1, H2, and H3 can be the same or different. In FIG. 5, the sizes of the holes H1, H2, and H3 can be different. The size of the hole H1 is smaller than the size of the hole H2, and the size of the hole H2 is smaller than the size of the hole H3. This is merely an example, and the sizes of the holes H1, H2, and H3 can be adjusted according to requirements.

In addition, the depths of any two of the hole H1, the hole H2, and the hole H3 can be the same or different. The depth of each hole (e.g., the hole H1, the hole H2, the hole H3) typically depends on the thickness of the covering layer in which it is formed. In the embodiments, the thickness of each covering layer can be adjusted according to actual design requirements.

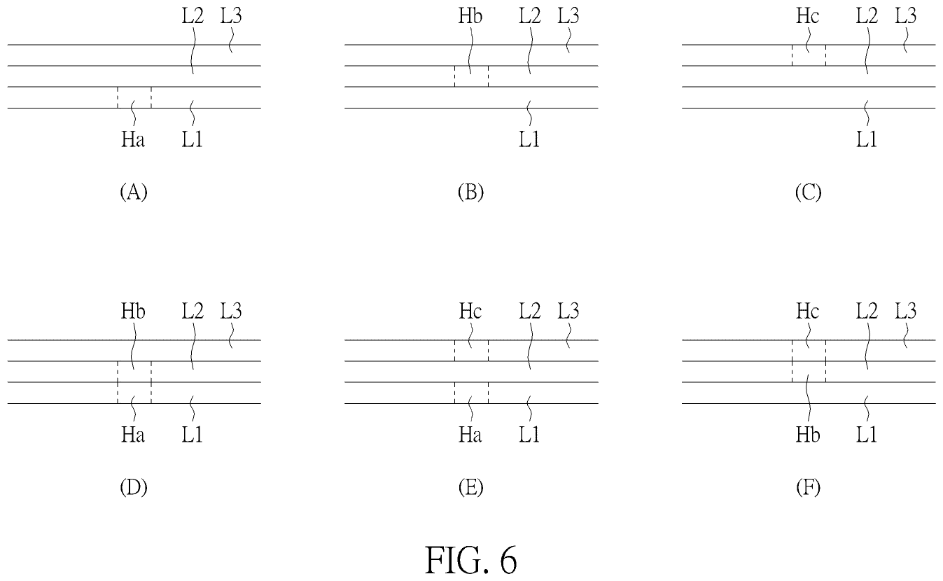

FIG. 6 shows a plurality of three-layer stacked structures according to embodiments. In each example of FIG. 6, the bottommost covering layer can be referred to as layer L1, the topmost covering layer can be referred to as layer L3, and the middle covering layer can be referred to as layer L2.

In FIGS. 6(A), 6(B), 6(C), 6(D), 6(E), and 6(F), the layer having a hole can be corresponding to the aforementioned covering layer 110, and the other two layers can be corresponding to the aforementioned covering layers 120 and 130. As described above, one or both of the covering layer 120 and the covering layer 130 can be without a hole or can have a hole.

FIGS. 6(A), 6(B), and 6(C) show examples where one layer of the three-layer stacked structure has a hole and the other two layers are without holes. FIGS. 6(D), 6(E), and 6(F) show examples where one layer of the three-layer stacked structure is without a hole and the other two layers have holes. As for examples where all three layers have holes, since they are similar to FIG. 5, further description is omitted.

In FIG. 6, when the layer L1 has a hole, the hole can be designated as Ha. When the layer L2 has a hole, the hole can be designated as Hb. When the layer L3 has a hole, the hole can be designated as Hc.

Each of the holes Ha, Hb, and Hc can partially overlap with a projection of a portion of an edge of the aforementioned antenna radiator 105 in a top view.

In FIG. 6(D), the hole Ha and the hole Hb can at least partially overlap in a top view. In FIG. 6(E), the hole Ha and the hole Hc can at least partially overlap in a top view. In FIG. 6(F), the hole Hb and the hole Hc can at least partially overlap in a top view.

Regarding the sizes of the holes in the top view, the sizes of any two of the holes Ha, Hb, and Hc can be the same or different. If the hole Ha and the hole Hb have the same size, this can be expressed as Ha=Hb; if the hole Ha and the hole Hb have different sizes, this can be expressed as Ha≠Hb. In FIG. 6, Ha=Hb, Ha≠Hb, Ha=Hc, Ha≠Hc, Hb=Hc, and Hb≠Hc all fall within the scope of embodiments. As previously mentioned, the depths of any two of holes Ha, Hb, and Hc can be the same or different. The depth of each hole (e.g., Ha, Hb, and Hc) can depend on the thickness of the corresponding covering layer in which the hole is formed. Any possible combinations of hole sizes and hole depths fall within the scope of embodiments.

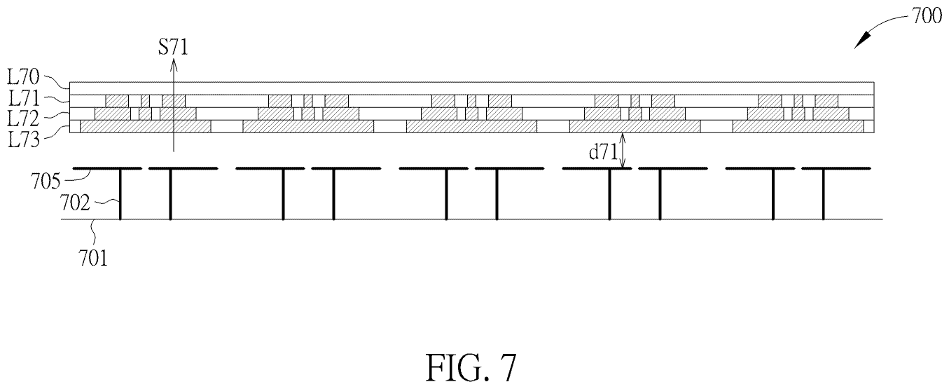

FIG. 7 shows an antenna device 700 according to an embodiment. FIG. 7 is a cross-sectional view. The antenna device 700 can include an antenna radiator 705, and covering layers L73, L72, L71, and L70 positioned above the antenna radiator 705. From a side view, the sequence from top to bottom is the layer L70, the layer L71, the layer L72, the layer L73, and the antenna radiator 705. The layer L73 and the antenna radiator 705 can be separated by a distance d71 less than 0.1 wavelength of a wireless signal S71 (expressed as d71<0.1λ). The antenna radiator 705 can be positioned on a plane 701 and supported by a fixing element 702. The plane 701 can be a ground plane.

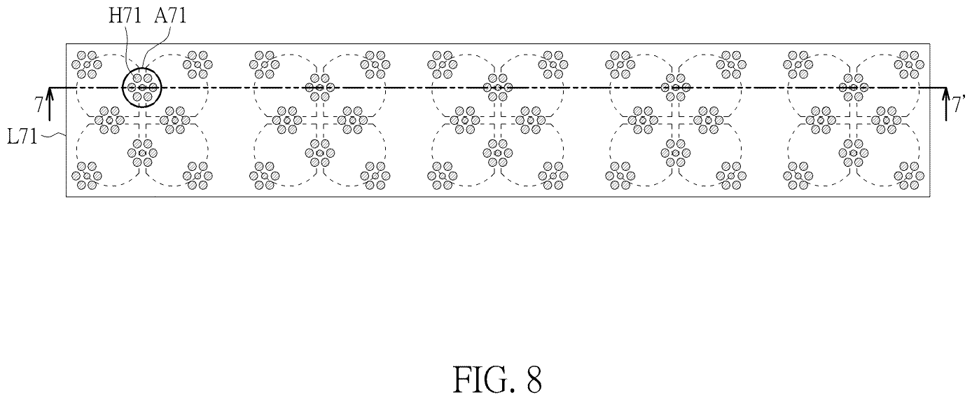

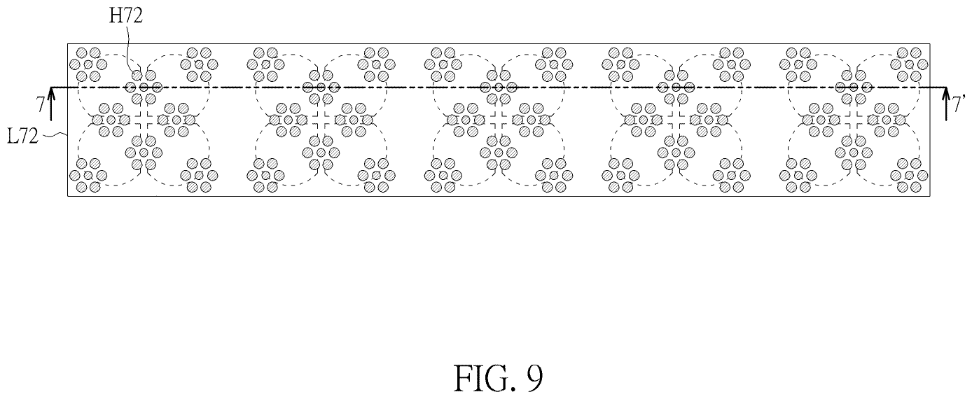

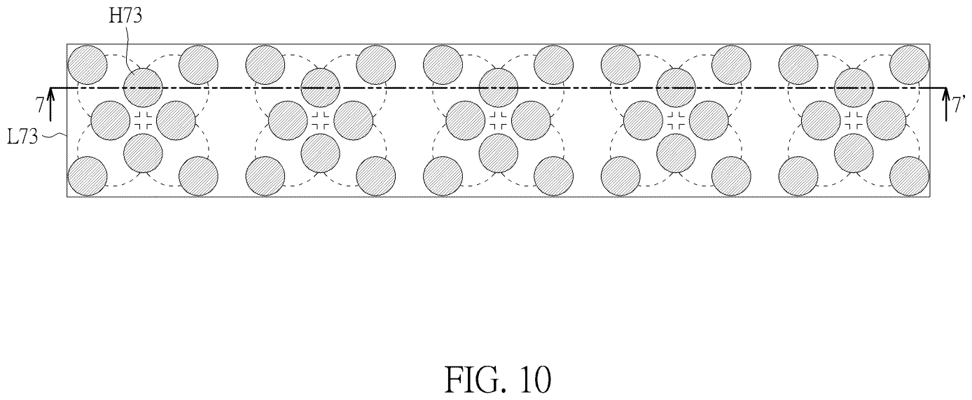

FIG. 8 shows the covering layer L71 in FIG. 7. FIG. 9 shows the covering layer L72 in FIG. 7. FIG. 10 shows the covering layer L73 in FIG. 7. FIG. 8, FIG. 9 and FIG. 10 show a top view of each layer. The cross-sectional view of each layer in FIG. 7 can be the cross-sectional view taken along reference line 7-7′ in FIG. 8, FIG. 9 and FIG. 10. As shown in FIG. 8 to FIG. 10, the antenna radiator 705 can be arranged in a four-leaf clover-like manner in the top view. In FIG. 8 to FIG. 10, the antenna radiator 705 is shown in dashed lines to indicate that it is located below the covering layers and is covered thereby.

In the layer L73, there can be a plurality of holes H73 positioned near edges of the antenna radiator 705 in the top view. The layer L72 can have a plurality of holes H72. The layer L73 can have a plurality of holes H73.

As shown in FIG. 8 to FIG. 9, a set of holes H72 can be arranged corresponding to a hole H73. In this example, seven holes H72 can be located above a hole H73 to substantially align with the projection area near the corresponding H73. In this example, seven holes H71 can be located above a hole H73 to substantially align with the projection area near the corresponding H73.

As shown in FIG. 7 to FIG. 10, the shapes and/or sizes of the holes in each layer can be different. Taking FIG. 7 as an example, the bottommost holes (H73) can be the larger, the middle layer holes (H72) can be medium-sized, and the upper holes (H71) can be smaller. In this example, the topmost layer L70 can be without holes. By using the aforementioned holes, the dielectric constants of each layer can be adjusted, and the performance of the transmitted signal S71 can be adjusted.

Taking FIG. 8 and FIG. 9 as examples, each hole within a group is positioned near the edges of the antenna radiator in the top view. While individual holes are located near the antenna radiator edges, each hole does not necessarily overlap with the antenna radiator edge itself. When considering the overall area occupied by a group of holes, the spatial relationship differs from individual hole positioning. As illustrated by area A71 in FIG. 7, a portion of the edge of antenna radiator 705 passes through the collective area A71 that encompasses the hole group when viewed from above. This arrangement allows the hole group as a whole to maintain the desired spatial relationship with the antenna radiator edge, even though individual holes within the group may not directly overlap with the antenna radiator boundary. The collective positioning of the hole group ensures proper electromagnetic interaction while providing design flexibility for individual hole placement within the designated area. When the projection of a hole in a covering layer is close to the edge of antenna radiator 705, but the edge of antenna radiator 705 does not pass through the projection of the hole, this can also be used to adjust wireless signals and falls within the scope of embodiments.

In the examples of FIG. 7 to FIG. 10, the antenna radiator 705 can be arranged in a four-leaf clover-like configuration in a top view, which is exemplary, and embodiments are not limited thereto. In other embodiments, according to requirements, the antenna radiator 705 can have a circular, rectangular, elliptical, or other suitable shape in a top view.

The holes formed in the covering layers described herein can have cross-sectional areas that are circular, elliptical, triangular, quadrilateral, cross-shaped, rhombic, grid-shaped, concave polygonal, star-shaped concave polygonal, hourglass-shaped, or other suitable configurations.

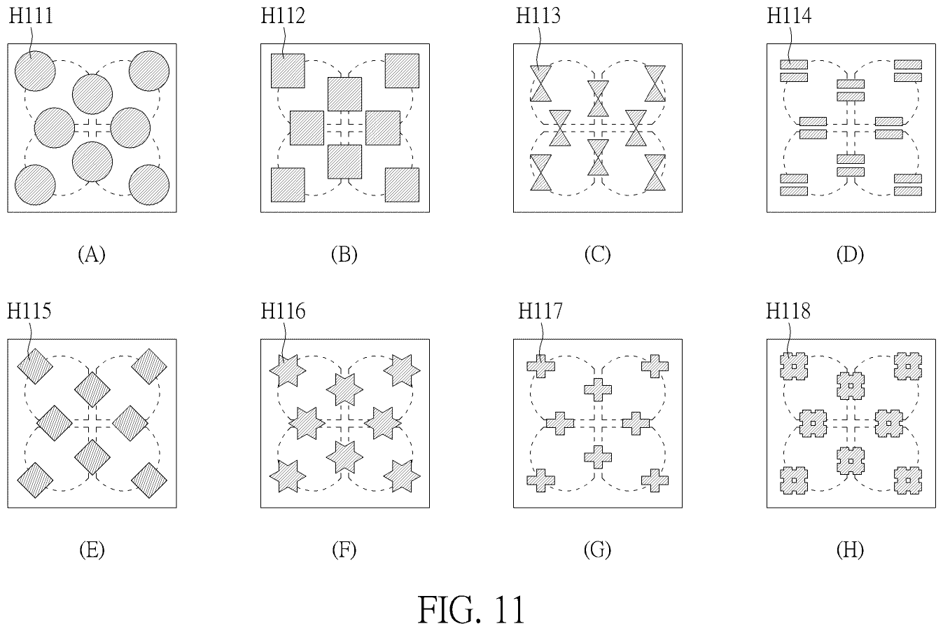

FIG. 11 shows a plurality of hole shapes applicable to at least one covering layer of the antenna device in top view. In FIG. 11(A), the hole H111 has a circular shape. In FIG. 11(B), the hole H112 has a rectangular shape. In FIG. 11(C), the hole H113 has an hourglass shape. In FIG. 11(D), the hole H114 has an equal sign shape. In FIG. 11(E), the hole H115 has a rhombic shape. In FIG. 11(F), the hole H116 has a concave polygonal shape. In FIG. 11(G), the hole H117 has a cross shape. In FIG. 11(H), the hole H118 has a grid shape. FIG. 11 provides some examples, but embodiments are not limited thereto. Any suitable hole shapes fall within the scope of embodiments.

Each covering layer described above can include a dielectric layer of a plastic circuit board, a non-conductive layer of a semiconductor package structure, a molding layer, or an additional dielectric layer. According to embodiments, the covering layers and their associated holes can be fabricated using at least one of the following manufacturing approaches: machining processes, semiconductor fabrication processes, packaging processes, printed circuit board processing procedures, or plastic molding processes. The embodiments encompass various manufacturing methodologies and are not limited to machining processes alone. The holes formed in different layers can be filled with the same material, different materials, or can remain unfilled with air retained within the hole cavities.

The use of covering layers made from materials with different dielectric constants creates interfaces where radio waves undergo refraction due to changes in propagation velocity. Furthermore, by integrating holes within these layers and varying their size, density, shape, or filling material (such as air or other dielectrics), the effective dielectric constant of each layer or specific regions within it can be precisely adjusted. The presence of holes reduces the effective dielectric constant of a region compared to solid dielectric material. Through the combination of material selection for each layer and hole design (including the presence or absence of holes, their sizes, and the distribution and combination of various covering layers with holes), a spatially profiled effective dielectric constant can be created above the antenna radiator. This effective dielectric constant distribution (which can exhibit gradual, stepwise variations, or more complex patterns) enables the multilayer covering structure to function overall as a customized dielectric lens or wavefront control element. This dielectric lens can then be designed to refract radio waves passing through according to specific objectives. For example, if designed to cause beam divergence, it can expand the coverage area (i.e., beam scanning range) of a phased antenna array; alternatively, it can be designed to steer beams toward specific directions, focus beam energy, or shape beams in particular ways, thereby achieving precise control over the refraction paths of radio waves.

In summary, the antenna devices provided by the embodiments can effectively reduce the overall antenna device dimensions. Since precise shape sculpting of dielectric layers above the antenna through machining processes is not required, the engineering complexity can be significantly reduced while enhancing the precision and accuracy of the antenna device. These improvements contribute to enhanced antenna performance tuning, improved compactness, and increased design flexibility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna device, comprising:
an antenna radiator configured to transmit a wireless signal;
a first covering layer formed above the antenna radiator;
wherein the wireless signal is transmitted through at least the first covering layer, the antenna radiator and the first covering layer are separated by a predetermined distance, and the predetermined distance is less than 1/10 of a wavelength of the wireless signal; and
the first covering layer has a first hole.

2. The antenna device of claim 1, wherein a portion of an orthogonal projection of an edge of the antenna radiator passes through the first hole in a top view.

3. The antenna device of claim 1, wherein a cross-sectional area of the first hole is circular, elliptical, triangular, quadrilateral, cross-shaped, rhombic, grid-shaped, concave polygonal, star-shaped concave polygonal, or hourglass-shaped.

4. The antenna device of claim 1, further comprising:
a second covering layer formed adjacent to the first covering layer;
wherein the wireless signal is transmitted through the first covering layer and the second covering layer.

5. The antenna device of claim 4, wherein the second covering layer has a second hole, and projections of the first hole and the second hole at least partially overlap.

6. The antenna device of claim 5, wherein the first hole and the second hole have different sizes.

7. The antenna device of claim 5, wherein the first hole is filled with a first material, and the second hole is filled with a second material.

8. The antenna device of claim 7, wherein the first material and the second material are the same.

9. The antenna device of claim 5, wherein the first hole and the second hole have the same shape in a top view.

10. The antenna device of claim 1, further comprising:
a second covering layer formed adjacent to the first covering layer; and
a third covering layer formed adjacent to one of the first covering layer and the second covering layer;
wherein the first covering layer, the second covering layer and the third covering layer form a three-layer stacked structure.

11. The antenna device of claim 10, wherein in the three-layer stacked structure, a topmost layer has a first effective dielectric constant, a middle layer has a second effective dielectric constant, a bottom layer has a third effective dielectric constant, and the second effective dielectric constant is between the first effective dielectric constant and the third effective dielectric constant.

12. The antenna device of claim 10, wherein the second covering layer has a second hole, and projections of the first hole and the second hole at least partially overlap.

13. The antenna device of claim 12, wherein the first hole and the second hole have different sizes.

14. The antenna device of claim 10, wherein the second covering layer has a second hole, the third covering layer has a third hole, and projections of the first hole, the second hole, and the third hole at least partially overlap.

15. The antenna device of claim 14, wherein at least two of the first hole, the second hole, and the third hole have different sizes.

16. The antenna device of claim 1, wherein the first covering layer is a dielectric layer of a plastic circuit board, a non-conductive layer of a semiconductor package structure, a molding layer, or an additional dielectric layer.
